(19) United States
(12) Patent Application Publication
(10) Pub. No.: US 2022/0038444 A1
(43) Pub. Date: Feb. 3, 2022

(54) CLOUD DEVICE, APPLICATION PROCESSING METHOD, ELECTRONIC DEVICE AND STORAGE MEDIUM

(71) Applicant: BOE TECHNOLOGY GROUP CO., LTD., Beijing (CN)

(72) Inventor: Yingjie LI, Beijing (CN)

(73) Assignee: BOE TECHNOLOGY GROUP CO., LTD., Beijing (CN)

(21) Appl. No.: 17/309,453

(22) PCT Filed: May 25, 2020
(86) PCT No.: PCT/CN2020/092014

§ 371 Date: May 27, 2021

(30) Foreign Application Priority Data
Jun. 19, 2019 (CN) 201910532955.4

(51) Int. Cl. H04L 29/06; G06F 9/445; G06F 9/451

(52) U.S. Cl. CPC H04L 63/08; G06F 9/451; G06F 9/44505

(57) ABSTRACT

A cloud device, an application processing method, an electronic device and a storage medium. The cloud device includes a memory and a processor. The processor is configured to execute the following instructions stored in the memory: receiving identity information transmitted by a client, verifying the identity information to obtain a successful verification result; creating an independent operating environment corresponding to the client according to the successful verification result; acquiring an application list display interface, and transmitting the application list display interface to the client; receiving a target application selected by the client in the application list display interface, and transmitting a program interface corresponding to the target application to the client.

### CROSS-REFERENCE TO RELATED APPLICATION

This application claims the priority of Chinese Application No. 201910532955.4, filed on Jun. 19, 2019, which is incorporated herein by reference in its entirety.

### TECHNICAL FIELD

The present disclosure relates to the field of cloud processing technology, and in particular to a cloud device, an application processing method, an electronic device and a storage medium.

### BACKGROUND

With gradual development of the Android system, its application ecosystem has become more and more complete and large. Many applications (APP) for news, short videos, social networking applications, web browsing and other functions have become quite popular, and many business services and information distribution are completed through APPs. However, at the same time, due to the large number of APPs, an installed APP with low usage frequency is inconvenient for users to use and occupy resources, or some APP may only have an Android version which cannot be used in the user's IOS and other operating systems. At this point, a device with an Android operating system that accesses the cloud through a web page can solve the foregoing problems of resources occupied by locally installed APP and inability to use some APP.

### SUMMARY

The present disclosure discloses a cloud device, including: a memory and a processor. The processor is configured to execute the following instructions stored in the memory: receiving identity information transmitted by a client, verifying the identity information to obtain a successful verification result; creating an independent operating environment corresponding to the client according to the successful verification result; acquiring an application list display interface, and transmitting the application list display interface to the client; receiving a target application selected by the client in the application list display interface, and transmitting a program interface corresponding to the target application to the client.

Optionally, the processor further executes the following instructions stored in the memory: in a case that the identity information verification is unsuccessful, creating a disk partition corresponding to the client; after the disk partition is created, acquiring a verification successful result corresponding to the client.

Optionally, the processor further executes the following instructions stored in the memory: starting a process corresponding to the disk partition, and acquiring the application list display interface through the process.

Optionally, the processor further executes the following instructions stored in the memory: transmitting the application list display interface to the client in form of a video stream; monitoring a selection event performed by the client on the target application on the application list display interface; receiving the target application selected by the client according to the selection event; in a case that the client is a registered client, acquiring the program interface corresponding to the target application, and transmitting the program interface to the client.

Optionally, the processor further executes the following instructions stored in the memory: in a case that the client logs in to the target application for the first time, acquiring a simulated registration interface corresponding to the target application; transmitting the simulated registration interface to the client in form of a video stream; monitoring and receiving registration information corresponding to the target application input by the client on the simulated registration interface; acquiring the program interface corresponding to the target application according to the registration information; transmitting the program interface to the client.

Optionally, the processor further executes the following instructions stored in the memory: receiving an interface switching operation event performed by the client; analyzing the interface switching operation event to obtain an analysis result; determining an interface identifier corresponding to a switched interface according to the analysis result; acquiring a switched display interface according to the interface identifier; transmitting the switched display interface to the client.

Optionally, the processor further executes the following instructions stored in the memory: monitoring a download operation event performed by the client on the target application on the application list display interface; analyzing the download operation event to obtain an analysis result; determining an identifier of the target application according to the analysis result; acquiring an installation package corresponding to the target application according to the identifier; acquiring a selection interface of whether to install the installation package; transmitting the selection interface to the client in form of a video stream; in a case of monitoring a selection-installation operation event performed by the client on the selection interface, installing the installation package; wherein the application list display interface displays the target application.

Optionally, the processor further executes the following instructions stored in the memory: receiving an installation package of the target application uploaded by the client; installing the installation package; wherein the application list display interface displays the target application.

The present disclosure further provides an application processing method, including: receiving identity information transmitted by a client, verifying the identity information to obtain a successful verification result; creating an independent operating environment corresponding to the client according to the successful verification result; acquiring an application list display interface; transmitting the application list display interface to the client; receiving a target application selected by the client in the application list display interface, and transmitting a program interface corresponding to the target application to the client.

Optionally, the step of receiving identity information transmitted by a client, verifying the identity information to obtain a successful verification result, includes: in a case that the identity information verification is unsuccessful, creating a disk partition corresponding to the client; after the disk partition is created, acquiring a verification successful result corresponding to the client.

Optionally, the step of acquiring an application list display interface, includes: starting a process corresponding to the disk partition, and acquiring the application list display interface through the process.

Optionally, the step of transmitting the application list display interface to the client, includes: transmitting the application list display interface to the client in form of a video stream. The step of receiving a target application selected by the client in the application list display interface, and transmitting a program interface corresponding to the target application to the client, includes: monitoring a selection event performed by the client on the target application on the application list display interface; receiving the target application selected by the client according to the selection event; in a case that the client is a registered client, acquiring the program interface corresponding to the target application, and transmitting the program interface to the client.

Optionally, after the step of receiving the target application selected by the client according to the selection event, the method further includes: in a case that the client logs in to the target application for the first time, acquiring a simulated registration interface corresponding to the target application; transmitting the simulated registration interface to the client in form of a video stream; monitoring and receiving registration information corresponding to the target application input by the client on the simulated registration interface; acquiring the program interface corresponding to the target application according to the registration information; transmitting the program interface to the client.

Optionally, after the step of acquiring the program interface corresponding to the target application, and transmitting the program interface to the client, the method further includes: receiving an interface switching operation event performed by the client; analyzing the interface switching operation event to obtain an analysis result; determining an interface identifier corresponding to a switched interface according to the analysis result; acquiring a switched display interface according to the interface identifier; transmitting the switched display interface to the client.

Optionally, before acquiring an application list display interface, the method further includes: receiving an installation package of the target application uploaded by the client; installing the installation package; wherein the application list display interface displays the target application.

Optionally, before acquiring an application list display interface, the method further includes: monitoring a download operation event performed by the client on the target application on the application list display interface; analyzing the download operation event to obtain an analysis result; determining an identifier of the target application according to the analysis result; acquiring an installation package corresponding to the target application according to the identifier; acquiring a selection interface of whether to install the installation package; transmitting the selection interface to the client; in a case of monitoring a selection-installation operation event performed by the client on the selection interface, installing the installation package; wherein the application list display interface displays the target application.

The present disclosure further provides an electronic device, including: a processor; a memory configured to store executable instructions of the processor. The processor is configured to execute any one of the forgoing application processing method.

The present disclosure further provides a computer-readable storage medium including a computer program stored thereon; wherein the computer program is executed by a processor to implement any one of the forgoing application processing method.

### BRIEF DESCRIPTION OF THE DRAWINGS

FIG. 1 shows a schematic structural diagram of a cloud device according to an embodiment of the present disclosure;

FIG. 2 shows a schematic diagram of a cloud device and shared users according to an embodiment of the present disclosure;

FIG. 3 shows a schematic diagram of a cloud device according to an embodiment of the present disclosure;

FIG. 4 shows a flowchart of steps of an application processing method according to an embodiment of the present disclosure; and

FIG. 5 shows a schematic diagram of a cloud device according to an embodiment of the present disclosure.

### DETAILED DESCRIPTION

In order to make the foregoing objectives, features and advantages of the present disclosure more apparent and understandable, the present disclosure will be further described in detail hereinafter with reference to the accompanying drawings and embodiments.

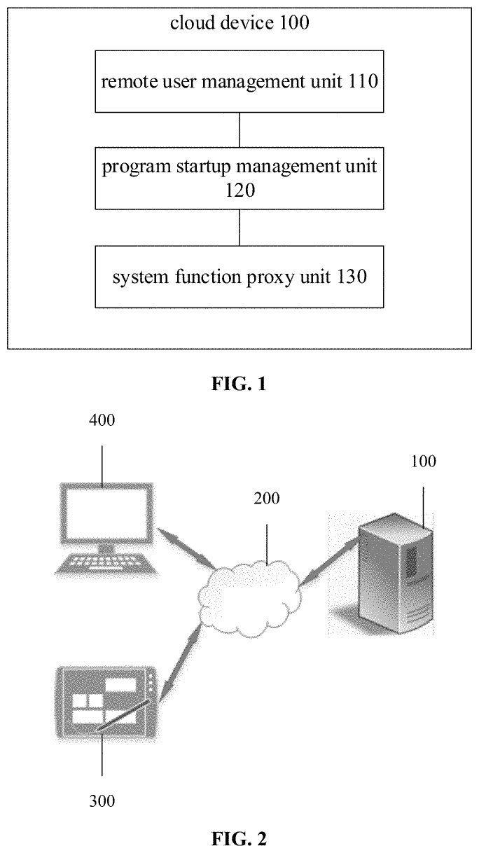

Referring to FIG. 1, it shows a schematic structural diagram of a cloud device according to an embodiment of the present disclosure.

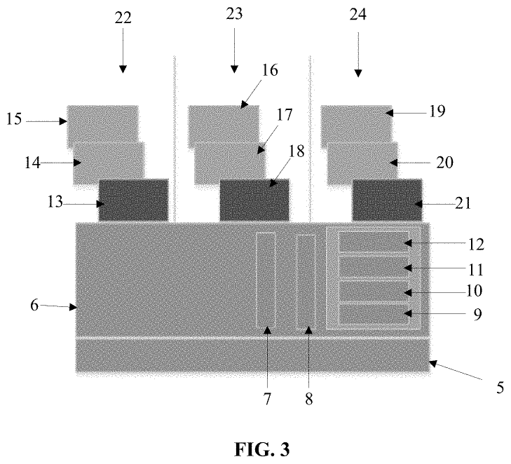

A network architecture of the embodiment of the present disclosure is described hereinafter with reference to FIG. 2.

Referring to FIG. 2, it shows a schematic diagram of a cloud device and shared users according to an embodiment of the present disclosure. As shown in FIG. 2, it shows a cloud device 100, a network 200, a first client 300 and a second client 400. The cloud device 100 is connected to the first client and the second client through the network. That is, the first client performs data interaction with the cloud device 100 through the network 200, and the second client performs data interaction with the cloud device 100 through the network 200.

The embodiments of the present disclosure aim to establish data interaction between one cloud device and multiple (two or more) clients, and one cloud device can provide corresponding services for the multiple clients when the multiple clients share one application, i.e., creating an independent operation environment corresponding to each client. Then, when various clients nm the same application, data interaction process and data storage will not interfere with each other. Details are described hereinafter in the following process.

The cloud device according to the embodiments of the present disclosure mainly involves improvements of an application framework layer or improvements of an application (APP) layer. In some embodiments, the cloud device may be a device installed with an Android operating system. Correspondingly, the application framework layer may be a framework layer, and the framework layer is an Application Programming Interface (API) layer and C/C++ API for calling Linux commands provided by the Android operating system for the application layer. In some embodiments, the cloud device may be a software and hardware device running the Android operating system, such as a physical machine installed with the Android operating system, a virtual machine installed with the Android operating system, or a simulator installed with the Android operating system.

In a case of using the improved solution of the APP layer, a process (such as a ServiceManager simulation process) may be started by declaring Activity and process name in an AndroidManifest.xml list in advance. Other parts are similar to modules added in the framework layer. By taking modification of the framework layer as an example, a specific implementation scheme is described hereinafter.

In conjunction with FIG. 3, an improved framework layer is described in detail hereinafter.

FIG. 3 shows a schematic diagram of a cloud device according to an embodiment of the present disclosure. As shown in FIG. 3, it shows a kernel driver (KERNEL&DRIVER) 5, a framework layer 6, a remote user management unit 7, a program startup management unit 8, a system function proxy unit composed of a package management module 9, an application activity management module 10, an input management module 11 and a window management module 12, a first client 22, a second client 23, a N-th client 24. The first client includes an APP1 13, an APP2 14 and an APPN 15. The second client includes an APP1 16, an APP2 17 and an APPN 18. The N-th client includes an APP1 19, an APP2 20 and an APPN 21.

In the embodiment of the present disclosure, by improving the framework layer, when the first client, the second client and the N-th client are running the APP1 at the same time, an independent operating environment and storage space can be created for each of the first client, the second client and the N-th client, to separate data of different clients, thereby ensuring that interactive data generated by different clients does not interfere with each other while ensuring that multiple clients can share one cloud device at the same time.

In some embodiments, in order to support more users, virtualization technology can further be used to virtualize multiple foregoing framework layers or application layers in the cloud device. The framework layer or application layer includes a remote user management unit 7, a program startup management unit 8, a package management module 9, an application activity management module 10, an input management module 11 and a window management module 12. The virtualization technology is a resource management technology, which abstracts and transforms various physical resources of computers such as servers, networks, memories and storages, to break inseparable barriers between physical structures, thereby allowing users to use these resources in a better way than original configuration.

As shown in FIG. 1, the cloud device 100 may include: a remote user management unit 110, a program startup management unit 120 and a system function proxy unit 130.

The remote user management unit 110 may be configured to receive identity information transmitted by a client, verify the identity information, and notify the program startup management unit 120 of a successful verification result.

The program startup management unit 120 may be configured to create an independent operating environment corresponding to the client according to the successful verification result; obtain an application list display interface, and transmit the application list display interface to the system function proxy unit 130.

The system function proxy unit 130 may be configured to transmit the application list display interface to the client, receive a target application selected by the client in the application list display interface, and transmit a program interface corresponding to the target application to the client.

In some embodiments, the remote user management unit 110 may exist as an Android application package (APK) in a cloud device installed with the Android operating system, or may share a process with other functional module and exist as a module, or may be in other device such as an independent server connected to the cloud device installed with the Android operating system.

In some embodiments, the program startup management unit 120 is configured to start a process of an independent namespace for the client. The namespace includes a mount namespace, etc., to distinguish resource spaces of different users. The program startup management unit 120 may be a newly added program in the framework layer, or may be implemented by modifying a zygote process in the Android operating system. For a client which logs in for the first time, the program startup management unit 120 first starts a ServiceManager simulation process. The ServiceManager simulation process acts as a proxy for some functions of the ServiceManager of the Android operating system. The ServiceManager simulation process has registered simulation service in the ServiceManager service of the Android operating system, such as a simulation service with a service name of ServiceSim. After the program startup management unit 120 creates a Dalvik virtual machine or an art virtual machine needed for operation of the ServiceManager simulation process that creates an independent namespace for the terminal and completes loading of a class corresponding to a target application and a class of the ServiceManager simulation process, the program startup management unit 120 replaces sServiceManager static variable of ServiceManager class with a service interface implementation class corresponding to IBinder object of ServiceSim. After that, all target applications (such as APK program) started by the program startup management unit 120 obtain the ServiceManager simulation process, they obtain the ServiceSim simulation service.

In some embodiments, the system function proxy unit 130 may run in one process or multiple processes. In the embodiment of the present disclosure, the system function proxy unit 130 runs in one process as an example for illustration.

In the embodiment of the present disclosure, the client's identity information may be identity information such as user name and password entered when the client logs in to an application through the web page. The client may register in the cloud device 100 in advance. When the client logs in to the cloud device 100 again, the cloud device 100 may compare login information entered by the client this time with pre-stored identity information of the client, to verify the identity information of the client.

Of course, the verification result corresponding to the client's identity information may include two types, namely, a successful verification result and an unsuccessful verification result.

When the remote user management unit 100 receives the identity information transmitted by the client and successfully verifies the identity information, it will notify the program startup management unit 120 of a successful verification result.

The program startup management unit 120 can create an independent operating environment corresponding to the client according to the successful verification result. That is, the independent operating environment is an operating environment corresponding to the client. In a case that there are multiple clients at the same time, an independent operating environment corresponding to each client can be created respectively, so that the cloud device 100 can simultaneously provide services for multiple clients while ensuring that interaction data generated by the multiple clients is isolated from each other.

The application list display interface is a display interface of the application list management program, and at least displays a list of applications and a search entry for an application that is not installed on the cloud device. The list of applications includes applications installed on the cloud device 100, and various APPs which are recommended by the application list management program, not installed on the cloud device 100 and supportable to run, such as chat APPs, entertainment APPs, which may be specifically determined according to business requirements and is not limited in the embodiments of the present disclosure. The application list display interface further displays a search entry for an application that is not installed on the cloud device 100. Through the search entry, the client can search and download the application it desires to use.

When the client's identity information is successfully verified, the program startup management unit 120 can acquire the application list display interface, and transmit the application list display interface to the system function proxy unit 130.

The target application refers to an application selected by the client from the application list display interface.

Of course, the target application may be one application or multiple applications. For the target application being multiple applications, a client interface display switching operation performed by a user is involved to display an application currently running on the client; and then, the cloud device 100 can transmit different application interfaces to the client in real time according to the switching operation performed at the client. Specifically, detailed description will be given in the following steps, and will not be described here.

The program interface refers to an interface corresponding to the target application. For example, when the user starts to log in, the program interface is a first interface of the target application corresponding to the client's identity information, and when the user directly selects an interface such as mailbox inbox to display, the program interface is an inbox interface.

It is understandable that the foregoing examples are merely examples for better understanding of the technical solutions of the embodiments of the present disclosure, and are not limited to being the only examples of the embodiments of the present disclosure.

After the system function proxy unit 130 receives the application list display interface, the system function proxy unit 130 can transmit the application list display interface to the client, and monitor an operation performed by the client in the application list display interface to acquire a target application selected by the client on the application list display interface, and then transmit a program interface corresponding to the target application to the client.

The cloud device 100 according to the embodiment of the present disclosure can acquire the target application selected by the client according to the client's identity verification success information, and transmit the program interface corresponding to the target application to the client in real time, so that for different clients, data of different clients can be independent of each other. In this way, different clients can share computing resources and system processes in the same cloud device, thereby reducing waste of storage resources of the cloud device and improving utilization of the cloud device.

Next, the foregoing units provided in the embodiments of the present disclosure will be described in detail in combination with specific implementations.

In one specific implementation of the present disclosure, the remote user management unit 110 may further be configured to, create a disk partition corresponding to a client when the client's identity information verification is unsuccessful; after the disk partition is created, notify the program startup management unit 120 of a successful verification result corresponding to the client.

In some embodiments, after the disk partition is created, the disk partition is mounted. In order to enable one cloud device to support more clients, the disk partition may be mounted in a storage space outside the cloud device, for example, mounted in a network storage device or an external storage device.

In the embodiments of the present disclosure, different clients are corresponding to different disk partitions in the cloud device 100, so that data of different clients can be stored separately, as shown in the following Table 1.

TABLE 1

| Client | disk partition |
|---|---|
| Client 1 | Partition a |
| Client 2 | Partition b |
| Client 3 | Partition c |

It can be seen from the foregoing Table 1 that, in the cloud device 100, a client 1 is corresponding to partition a, a client 2 is corresponding to partition b, and a client 3 is corresponding to partition c.

It is understandable that the foregoing examples are merely examples for better understanding of the technical solutions of the embodiments of the present disclosure, and are not limited to being the only examples of the embodiments of the present disclosure.

In a case that the client's identity information verification is unsuccessful, it means that the client is a client which logs in for the first time and has not previously registered identity information in the cloud device. In this access, a corresponding disk partition can be created for the client according to identity information entered by the client, thereby completing a registration process of the client's identity information.

After the disk partition is created for the client, i.e., after the registration of the client's identity information on the cloud device 100 is completed, the program startup management unit 120 may be notified of the client's identity verification result.

Of course, for a client that has not entered identity information, it can return an identity information input interface to the client and receive identity information entered by the client to complete the client's identity information registration process of the foregoing creation of the disk partition. In a case that the client refuses to input identity information, the client's current access behavior may be rejected, and the remote user management unit 110 transmits an unsuccessful verification result to the program startup management unit 120.

One process of acquiring the application list display interface will be described in conjunction with the following specific implementation.

In another specific implementation of the present disclosure, the program startup management unit 120 may further be configured to start a process corresponding to the disk partition and acquire the application list display interface through the process.

In the embodiments of the present disclosure, different disk partitions may correspond to different processes. For example, the disk partition includes partition a and partition b, the partition a may be corresponding to a process 1, and the partition b may be corresponding to a process 2, and so on.

After the program startup management unit 120 receives the successful verification result of the client's identity information, the program startup management unit 120 can acquire the disk partition corresponding to the client and start the process corresponding to the disk partition.

In some embodiments, the process may be a ServiceManager simulation program process. The ServiceManager simulation process acts as a proxy for some functions of ServiceManager of the Android operating system. When acquiring a service in the ServiceManager simulation program process, in a case that the service has registered in the ServiceManager simulation program, the ServiceManager simulation program process returns the registered service; in a case that the service is not registered in the ServiceManager simulation program and the ServiceManager in the Android operating system is registered with the service, then the ServiceManager in the Android operating system returns the corresponding service.

In some embodiments, after the ServiceManager simulation program process is started, the service corresponding to the system function proxy unit 130 may be registered in the ServiceManager simulation program process, so as to subsequently acquire corresponding services through the ServiceManager simulation program process.

It is understandable that when multiple clients access at the same time, processes corresponding to various clients may be started sequentially, and operations of various clients can be distinguished according to the processes, thereby avoiding intricate storage of interactive data between the clients.

After starting the process corresponding to the disk partition, the process can be called to acquire the application list display interface. In the subsequent procedure, the application list display interface is transmitted to the client for display.

The system function proxy unit 130 according to the embodiment of the present disclosure is described as follows with reference to FIG. 3.

The system function proxy unit 130 may include: a window management module 12 and an input management module 11.

The window management module 12 may be configured to transmit the application list display interface to the client in the form of a video stream.

The input management module 11 may be configured to monitor a selection event of a target application performed by the client on the application list display interface, and transmit the target application selected by the client to the program startup management unit 120.

The program startup management unit 120 may further be configured to acquire a program interface corresponding to the target application in a case that the client is a registered client, and transmit the program interface to the client through the window management module 12.

In some embodiments, functions of the window management module 12 are the same as that of WindowManagerService (window management service) in the Android operating system, and their service names are also the same. The window management module 12 is used to act as a proxy of actual window management service of the Android operating system.

In the embodiment of the present disclosure, the window management module 12 may receive the application list display interface transmitted by the program startup management unit 120, generate a video stream corresponding to the application list display interface by performing video encoding processing on the application list display interface with a specific video encoding method, and then transmit the video stream to the client.

In some embodiments, functions of the input management module 11 are the same as that of InputManagerService (input management service) in the Android operating system, but its operation events (such as interface switching operation events) originate from the client. After receiving the client's operation event, the input management module 11 transmits the client's operation event to an event processing module of the target application.

The input management module 11 may monitor the operation performed by the client on the application list display interface. In a case that a target application selected by the client is monitored, the input management module 11 can feed back the target application to the program startup management unit 120.

Of course, the input of the client may further include other operations performed in the application program interface, such as clicking buttons, inputting characters in an input box, etc. These operations may be transmitted to the target application running on the current cloud device through the input management module 11 for event processing, which may cause a page jump in the target application, or a change in displayed content of this page, or application switching, etc.

The registered client here means that cloud device has allocated an independent running and storage environment for the client's account, so that the client can log in and return to an application list in a previous state. In a case of an unregistered client, the client does not install an application by itself, and then it can only return to a default application list.

In a case that the client is a registered client, the program startup management unit 120 may acquire the program interface corresponding to the target application, and transmit the program interface to the client through the window management module 12. That is, the program startup management unit 120 transmits the program interface to the window management module 12, and the window management module 12 encodes the program interface with a specific video encoding method to generate a video stream corresponding to the program interface, and transmits the program interface to the client in the form of a video stream.

In the foregoing specific implementation of the embodiments of the present disclosure, by simulating program running process, the client can log in and access the target application through the web page or the like without downloading the target application.

For a case where the client logs in to the target application for the first time, a detailed description will be given in conjunction with the following specific implementation.

In another specific implementation of the present disclosure, the program startup management unit 120 may further be configured to acquire a simulated registration interface corresponding to the target application when the client logs in to the target application for the first time, transmit the simulated registration interface to the window management module 12, and receive registration information corresponding to the target application input by the client from the window management module 12, and transmit a program interface to the window management module 12 according to the registration information.

The window management module 12 may further be configured to transmit the simulated registration interface to the client in the form of a video stream, monitor registration information entered by the client on the simulated registration interface, transmit the registration information to the program startup management unit 120, receive the program interface transmitted by the program startup management unit 120, and transmit the program interface to the client in the form of a video stream.

In the embodiment of the present disclosure, in a case that the client logs in to the target application for the first time, the program startup management unit 120 may acquire the simulated registration interface of the target application, which simulates registration function of the target application, and transmit the simulated registration interface to the window management module 12.

The window management module 12 may generate a video stream corresponding to the simulated registration interface by performing video encoding processing on the simulated registration interface with a specific video encoding method, and then transmits the video stream to the client for display.

The window management module 12 may monitor registration information input by the client on the simulated registration interface, and transmit the registration information to the program startup management unit 120.

After the program startup management unit 120 receives the registration information corresponding to the target application input by the client, the program startup management unit 120 can complete a registration process of the client in the target application according to the registration information. After the registration is successful, the program startup management unit 120 acquires a program interface corresponding to the target application, and transmits the program interface to the window management module 12.

After the window management module 12 receives the program interface transmitted by the program startup management unit 120, the window management module 12 can generate a video stream corresponding to the program interface by performing video encoding processing on the program interface with a specific video encoding method, and transmit the video stream to the client for display.

In the present disclosure, after the program interface is transmitted to the client, operations performed by the client may be monitored in real time, and operations such as interface switching can be completed according to the operations performed by the client. Specifically, a detailed description is given in the following specific implementation.

In another specific implementation of the present disclosure, the system function proxy unit 130 further includes an application activity management module 10.

The application activity management module 10 may be configured to receive the interface switching operation performed by the client, and transmit an interface switching operation event to an event processing module of the target application.

The event processing module may be configured to analyze the interface switching operation event, determine an interface identifier corresponding to a switched interface according to an analysis result, and transmit the interface identifier to the program startup management unit 120.

The program startup management unit 120 may further be configured to acquire a switched display interface according to the interface identifier, and transmit the switched display interface to the client through the window management module 12.

In some embodiments, functions of the application activity management module 10 are the same as functions of ActivityManagerService (application activity management service) in the Android operating system, so that the class of ActivityManagerService can be reused.

In the embodiment of the present disclosure, the interface switching operation event refers to a display interface switching operation performed by the client, for example, an operation of switching an interface displayed on the client from a display interface A to a display interface B.

The event processing module refers to a module in the application layer, used to process various operation events performed by the application corresponding to the client.

The interface identifier refers to an identifier corresponding to a display interface. In the embodiments of the present disclosure, the interface identifier is intended to refer to an identifier of a switched display interface.

The application activity management module 10 may receive the interface switching operation event performed by the client, and transmit the interface switching operation event to the event processing module of the target application.

The event processing module may analyze the interface switching operation event, determine a switched interface according to an analysis result, acquire the interface identifier corresponding to the interface, and transmit the interface identifier to the program startup management unit 120.

The program startup management unit 120 may acquire the switched display interface according to the interface identifier, and then transmit the switched display interface to the window management module 12.

The window management module 12 may generate a video stream corresponding to the switched display interface by performing video encoding processing on the switched display interface with a specific video encoding method, and transmit the video stream to the client, so that the client displays the switched display interface.

Of course, in a case that the target application is not installed, the cloud device 100 may further transmit a selection interface of a corresponding installation package to the client for the client to choose whether to install the target application. Specifically, a detailed description is given in the following specific implementation.

In another specific implementation of the present disclosure, the system function proxy unit 130 may further include: a package management module 9.

In some embodiments, functions of the package management module 9 are similar to functions of PackageManagerService (package management service) in the Android operating system. When the package management module 9 acquires an installation package of an application in the application list corresponding to the client, the package management module 9 may selectively filter out acquisition of an installation package of the application in the Android operating system.

The package management module 9 is configured to receive an installation package of the target application uploaded by the client, and install the installation package.

The program startup management unit 120 is further configured to acquire an application list display interface and transmit the application list display interface to the system function proxy unit. The application list display interface displays the target application.

After the package management module 9 installs the installation package, the application list display interface displays the target application.

In some embodiments, the client may download the installation package corresponding to the target application from a target application providing server, and then transmit the installation package to the cloud device. The package management module in the cloud device receives the installation package, and install the installation package corresponding to the target application.

In some embodiments, the application list display interface may be an application list display interface of an application list management program. After an independent running environment is created for the client, the application list management program corresponding to the client is started.

In some embodiments, the cloud device may also download the installation package corresponding to the target application from the target application providing server through the application list management program. Specifically, the application list management program downloads the installation package corresponding to the target application from the target application providing server; and the package management module 9 in the cloud device acquires the installation package. The process is described in detail as follows.

The input management module 11 is further configured to monitor a download operation event performed by the client on the target application on the application list display interface, and transmit the download operation event to the event processing module.

The event processing module is configured to analyze the download operation event, determine an identifier of the target application according to an analysis result, and transmit the identifier to the package management module.

The package management module 9 may be configured to acquire an installation package corresponding to the target application according to the identifier.

The program startup management unit 120 is further configured to acquire a selection interface of whether to install the installation package, and transmit the selection interface to the window management module 12.

The window management module 12 may be further configured to transmit the selection interface to the client in the form of a video stream.

The input management module 11 is further configured to monitor a selection-installation operation event performed by the client on the selection interface.

The package management module 9 is further configured to install the installation package.

The program startup management unit 120 is further configured to acquire an application list display interface, and transmit the application list display interface to the client through the window management module 12. The application list display interface displays the target application.

In some embodiments, in a case that the input management module 11 monitors that the client searches for a target application in the search entry displayed on the application list display interface and selects to download the target application, or monitors that the client selects to download a target application recommended by the application list display interface, the foregoing download operation event is transmitted to the event processing module to acquire an identifier of the target application, or the identifier of the target application selected by the client is directly transmitted to the package management module 9. Meanwhile, the application list management program downloads an installation package of the target application from the target application providing server, and the package management module 9 acquires the installation package corresponding to the target application from the application list management program. Then, the program startup management unit 120 acquires the selection interface of whether to install the installation package, and transmits the selection interface to the window management module 12. The window management module 12 transmits the selection interface to the client in the form of a video stream for the client to select whether to install the target application on the cloud device. In a case that the client selects to install the target application, that is, the input management module 11 monitors a selection-installation operation event performed by the client on the selection interface, the package management module 9 installs the installation package, and the program startup management unit 120 acquires an application list display interface. After the target application is installed, the application list display interface displays the target application, and the window management module 12 transmits the application list display interface to the client.

In the embodiments of the present disclosure, the installation package refers to an installation package corresponding to the target application.

The window management module 12 may generate a video stream corresponding to the selection interface of the installation package by performing video encoding processing on the selection interface of the installation package with a specific video encoding method, and transmit the video stream to the client so that the client can select whether to download and install the target application.

After the target application is installed, an icon of the target application is displayed in the application list for the client to select.

In the embodiments of the present disclosure, by simulating functions of the target application, various simulation functions of the target application can be displayed on the web page of the client.

In some embodiments, in a case that the client selects to log out on the web page, the program startup management unit in the cloud device cleans up, according to a certain policy, the ServiceManager simulation process and related application process running on the client. For example, the ServiceManager simulation process and related application process running on the client may be destroyed immediately, or may be maintained for a period of time, during which when the client logs in to the target application again, a state of the target application, when the target application was last exited, may be displayed.

In some embodiments, the foregoing modules in the system function proxy unit 130 may all exist in the form of services, and have all been registered with ServiceSim. In a case that the target application accesses these services, it accesses the ServiceManager simulation program process.

The cloud device according to the embodiment of the present disclosure receives identity information transmitted by the client, verifies the identity information to obtain a successful verification result, creates an independent operating environment corresponding to the client according to the successful verification result, acquires the application list display interface, transmits the application list display interface to the client, receives the target application selected by the client on the application list display interface, and transmits the program interface corresponding to the target application to the client. In the embodiments of the present disclosure, by creating an independent operating environment for each client, for different clients, data of different clients can be independent of each other, so that different clients can share computing resources and system processes in the same one system, thereby reducing waste of storage resources of the cloud device and improving utilization of the cloud device.

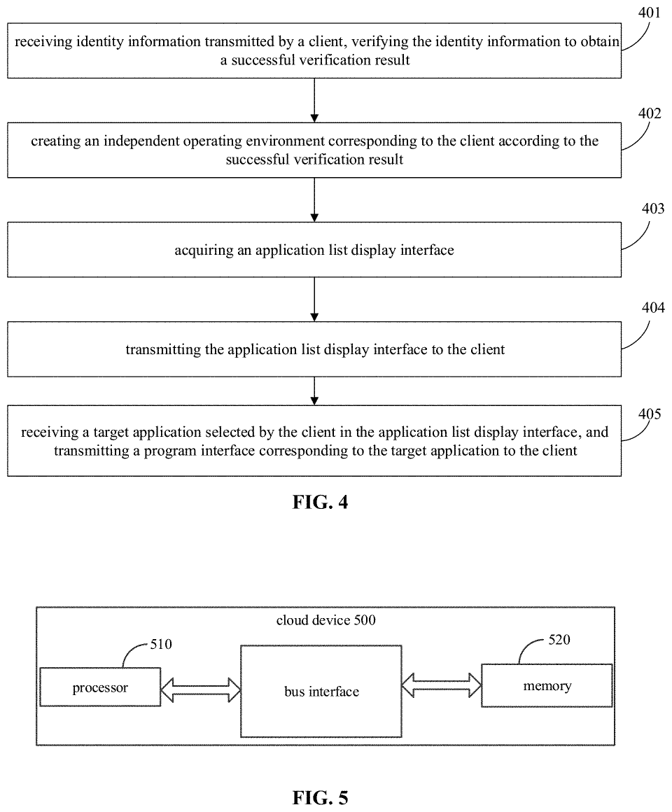

Referring to FIG. 4, it shows a flowchart of steps of an application processing method according to an embodiment of the present disclosure. The application processing method may specifically include the following steps.

Step 401: receiving identity information transmitted by a client, verifying the identity information to obtain a successful verification result.

Step 402: creating an independent operating environment corresponding to the client according to the successful verification result.

Step 403: acquiring an application list display interface.

Step 404: transmitting the application list display interface to the client.

Step 405: receiving a target application selected by the client in the application list display interface, and transmitting a program interface corresponding to the target application to the client.

Optionally, the foregoing step 403 may include:

starting a process corresponding to a disk partition, and acquiring the application list display interface through the process.

Optionally, the foregoing step 404 may include:

transmitting the application list display interface to the client in form of a video stream.

The foregoing step 405 may include:

monitoring a selection event performed by the client on the target application on the application list display interface;

receiving the target application selected by the client according to the selection event;

in a case that the client is a registered client, acquiring the program interface corresponding to the target application, and transmitting the program interface to the client.

Optionally, the method may further include:

in a case that the client logs in to the target application for the first time, acquiring a simulated registration interface corresponding to the target application;

transmitting the simulated registration interface to the client in form of a video stream;

monitoring and receiving registration information input by the client on the simulated registration interface;

acquiring the program interface corresponding to the target application according to the registration information;

transmitting the program interface to the client.

Optionally, the method may further include:

receiving an interface switching operation event performed by the client;

analyzing the interface switching operation event to obtain an analysis result;

determining an interface identifier corresponding to a switched interface according to the analysis result;

acquiring a switched display interface according to the interface identifier;

transmitting the switched display interface to the client.

Optionally, before acquiring the application list display interface, the method further includes:

receiving an installation package of the target application uploaded by the client;

installing the installation package;

where the application list display interface displays the target application.

Optionally, before acquiring the application list display interface, the method further includes:

monitoring a download operation event performed by the client on the target application on the application list display interface;

analyzing the download operation event to obtain an analysis result;

determining the identifier of the target application according to the analysis result;

acquiring an installation package corresponding to the target application according to the identifier;

acquiring a selection interface of whether to install the installation package;

transmitting the selection interface to the client;

in a case of monitoring a selection-installation operation event performed by the client on the selection interface, installing the installation package;

where the application list display interface displays the target application.

The application processing method according to the embodiments of the present disclosure includes: receiving identity information transmitted by the client, verifying the identity information to obtain a successful verification result, creating an independent operating environment corresponding to the client according to the successful verification result, acquiring the application list display interface, transmitting the application list display interface to the client, receiving the target application selected by the client on the application list display interface, and transmitting the program interface corresponding to the target application to the client. In the embodiments of the present disclosure, by creating an independent operating environment for each client, for different clients, data of different clients can be independent of each other, so that different clients can share computing resources and system processes in the same one system, thereby reducing waste of storage resources of the cloud device and improving utilization of the cloud device.

One embodiment of the present disclosure further provides a cloud device 500. As shown in FIG. 5, the cloud device 500 includes: a processor 510, and a memory 520 coupled to the processor 510 through a bus interface. The memory 520 is configured to store programs and data used by the processor when performing operations. The processor 510 calls and executes the programs and data stored in the memory 520 to perform the following functions.

The processor 510 executes the following instructions stored in the memory 520:

receiving identity information transmitted by a client, verifying the identity information to obtain a successful verification result;

creating an independent operating environment corresponding to the client according to the successful verification result;

acquiring an application list display interface, and transmitting the application list display interface to the client;

receiving a target application selected by the client in the application list display interface, and transmitting a program interface corresponding to the target application to the client.

Optionally, the processor 510 further executes the following instructions stored in the memory 520:

in a case that the identity information verification is unsuccessful, creating a disk partition corresponding to the client;

after the disk partition is created, acquiring a verification successful result corresponding to the client.

Optionally, the processor 510 further executes the following instructions stored in the memory 520: starting a process corresponding to the disk partition, and acquiring the application list display interface through the process.

Optionally, the processor 510 further executes the following instructions stored in the memory 520:

transmitting the application list display interface to the client in form of a video stream;

monitoring a selection event performed by the client on the target application on the application list display interface;

receiving the target application selected by the client according to the selection event;

in a case that the client is a registered client, acquiring the program interface corresponding to the target application, and transmitting the program interface to the client.

Optionally, the processor 510 further executes the following instructions stored in the memory 520:

in a case that the client logs in to the target application for the first time, acquiring a simulated registration interface corresponding to the target application;

transmitting the simulated registration interface to the client in form of a video stream;

monitoring and receiving registration information input by the client on the simulated registration interface;

acquiring the program interface corresponding to the target application according to the registration information;

transmitting the program interface to the client.

Optionally, the processor 510 further executes the following instructions stored in the memory 520:

receiving an interface switching operation event performed by the client;

analyzing the interface switching operation event to obtain an analysis result;

determining an interface identifier corresponding to a switched interface according to the analysis result;

acquiring a switched display interface according to the interface identifier;

transmitting the switched display interface to the client.

Optionally, the processor 510 further executes the following instructions stored in the memory 520:

monitoring a download operation event performed by the client on the target application on the application list display interface;

analyzing the download operation event to obtain an analysis result;

determining the identifier of the target application according to the analysis result;

acquiring an installation package corresponding to the target application according to the identifier;

acquiring a selection interface of whether to install the installation package;

transmitting the selection interface to the client in form of a video stream;

in a case of monitoring a selection-installation operation event performed by the client on the selection interface, installing the installation package;

where the application list display interface displays the target application.

Optionally, the processor 510 further executes the following instructions stored in the memory 520:

receiving an installation package of the target application uploaded by the client;

installing the installation package;

where the application list display interface displays the target application.

In addition, one embodiment of the present disclosure further provides an electronic device, including: a processor; and a memory for storing executable instructions of the processor. The processor may be configured to execute any one of the foregoing application processing methods.

One embodiment of the present disclosure further provides a computer-readable storage medium on which a computer program is stored. The computer program is executed by a processor to implement any one of the forgoing application program processing methods. The computer-readable storage medium, may be, for example, a read-only memory (ROM), a random access memory (RAM), a magnetic disk or an optical disk, etc.

For the foregoing method embodiments, for a brief description, they are all expressed as a series of action combinations, but those skilled in the art should know that the present disclosure is not limited by the described sequence of actions, because according to the present disclosure, some steps may be performed in other order or simultaneously. Moreover, those skilled in the art should also know that the embodiments described in the specification are all optional embodiments, and involved actions and modules are not necessarily required by the present disclosure.

The various embodiments in this specification are described in a progressive manner. Each embodiment focuses on differences from other embodiments, and the same or similar parts between the various embodiments may be referred to each other.

Finally, it should be noted that in this application, relational terms such as first and second are only used to distinguish one entity or operation from another entity or operation, and do not necessarily require or imply that there is any such actual relationship or sequence between these entities or operations. Moreover, the terms “comprise”, “include” or any other variants thereof are intended to cover non-exclusive inclusion, so that a process, method, commodity or device including a series of elements not only includes those elements, but also includes other elements that are not explicitly listed or also include elements inherent to this process, method, commodity or device. Without further restrictions, an element defined by the sentence “including a . . . ” does not exclude existence of other identical elements in the process, method, commodity or device including the element.

A cloud device, an application processing method, an electronic device and a computer-readable storage medium provided in the present disclosure are described in detail above. In this application, specific examples are used to illustrate the principles and implementations of the present disclosure. The description of the foregoing embodiments is only used to help understand the methods and core ideas of the present disclosure. Meanwhile, according to the ideas of the present disclosure, those of ordinary skill in the art may make modification to specific implementations and application scopes. In summary, the content of this specification should not be understood as a restriction to the present disclosure.

1. A cloud device comprising: a memory and a processor;
wherein the processor is configured to execute the following instructions stored in the memory:
receiving identity information transmitted by a client, verifying the identity information to obtain a successful verification result;
creating an independent operating environment corresponding to the client according to the successful verification result;
acquiring an application list display interface, and transmitting the application list display interface to the client;
receiving a target application selected by the client in the application list display interface, and transmitting a program interface corresponding to the target application to the client.

2. The cloud device according to claim 1, wherein the processor further executes the following instructions stored in the memory:
in a case that the identity information verification is unsuccessful, creating a disk partition corresponding to the client;
after the disk partition is created, acquiring a verification successful result corresponding to the client.

3. The cloud device according to claim 2, wherein the processor further executes the following instructions stored in the memory: starting a process corresponding to the disk partition, and acquiring the application list display interface through the process.

4. The cloud device according to claim 1, wherein the processor further executes the following instructions stored in the memory:
transmitting the application list display interface to the client in form of a video stream;
monitoring a selection event performed by the client on the target application on the application list display interface;
receiving the target application selected by the client according to the selection event;
in a case that the client is a registered client, acquiring the program interface corresponding to the target application, and transmitting the program interface to the client.

5. The cloud device according to claim 4, wherein the processor further executes the following instructions stored in the memory:
in a case that the client logs in to the target application for the first time, acquiring a simulated registration interface corresponding to the target application;
transmitting the simulated registration interface to the client in form of a video stream;
monitoring and receiving registration information corresponding to the target application input by the client on the simulated registration interface;
acquiring the program interface corresponding to the target application according to the registration information;
transmitting the program interface to the client.

6. The cloud device according to claim 4, wherein the processor further executes the following instructions stored in the memory:
receiving an interface switching operation event performed by the client;
analyzing the interface switching operation event to obtain an analysis result;
determining an interface identifier corresponding to a switched interface according to the analysis result;
acquiring a switched display interface according to the interface identifier;
transmitting the switched display interface to the client.

7. The cloud device according to claim 4, wherein the processor further executes the following instructions stored in the memory:
monitoring a download operation event performed by the client on the target application on the application list display interface;
analyzing the download operation event to obtain an analysis result;
determining an identifier of the target application according to the analysis result;
acquiring an installation package corresponding to the target application according to the identifier;
acquiring a selection interface of whether to install the installation package;
transmitting the selection interface to the client in form of a video stream;
in a case of monitoring a selection-installation operation event performed by the client on the selection interface, installing the installation package;
wherein the application list display interface displays the target application.

8. The cloud device according to claim 1, wherein the processor further executes the following instructions stored in the memory:
receiving an installation package of the target application uploaded by the client;
installing the installation package;
wherein the application list display interface displays the target application.

9. An application processing method, comprising:
receiving identity information transmitted by a client, verifying the identity information to obtain a successful verification result;
creating an independent operating environment corresponding to the client according to the successful verification result;
acquiring an application list display interface;
transmitting the application list display interface to the client;
receiving a target application selected by the client in the application list display interface, and transmitting a program interface corresponding to the target application to the client.

10. The method according to claim 9, wherein the step of receiving identity information transmitted by a client, verifying the identity information to obtain a successful verification result, includes:
in a case that the identity information verification is unsuccessful, creating a disk partition corresponding to the client;
after the disk partition is created, acquiring a verification successful result corresponding to the client.

11. The method according to claim 10, wherein the step of acquiring an application list display interface, includes:
starting a process corresponding to the disk partition, and acquiring the application list display interface through the process.

12. The method according to claim 9, wherein the step of transmitting the application list display interface to the client, includes: transmitting the application list display interface to the client in form of a video stream;
the step of receiving a target application selected by the client in the application list display interface, and transmitting a program interface corresponding to the target application to the client, includes:
monitoring a selection event performed by the client on the target application on the application list display interface;
receiving the target application selected by the client according to the selection event;
in a case that the client is a registered client, acquiring the program interface corresponding to the target application, and transmitting the program interface to the client.

13. The method according to claim 12, wherein after the step of receiving the target application selected by the client according to the selection event, the method further includes:
in a case that the client logs in to the target application for the first time, acquiring a simulated registration interface corresponding to the target application;
transmitting the simulated registration interface to the client in form of a video stream;
monitoring and receiving registration information corresponding to the target application input by the client on the simulated registration interface;
acquiring the program interface corresponding to the target application according to the registration information;
transmitting the program interface to the client.

14. The method according to claim 12, wherein after the step of acquiring the program interface corresponding to the target application, and transmitting the program interface to the client, the method further includes:
receiving an interface switching operation event performed by the client;
analyzing the interface switching operation event to obtain an analysis result;
determining an interface identifier corresponding to a switched interface according to the analysis result;
acquiring a switched display interface according to the interface identifier;
transmitting the switched display interface to the client.

15. The method according to claim 9, wherein before acquiring an application list display interface, the method further includes:
receiving an installation package of the target application uploaded by the client;
installing the installation package;
wherein the application list display interface displays the target application.

16. The method according to claim 9, wherein before acquiring an application list display interface, the method further includes:
monitoring a download operation event performed by the client on the target application on the application list display interface;
analyzing the download operation event to obtain an analysis result;
determining an identifier of the target application according to the analysis result;
acquiring an installation package corresponding to the target application according to the identifier;
acquiring a selection interface of whether to install the installation package;
transmitting the selection interface to the client;
in a case of monitoring a selection-installation operation event performed by the client on the selection interface, installing the installation package;
wherein the application list display interface displays the target application.

17. An electronic device, comprising:
a processor;
a memory configured to store executable instructions of the processor;
wherein the processor is configured to:
receive identity information transmitted by a client, verify the identity information to obtain a successful verification result;
create an independent operating environment corresponding to the client according to the successful verification result;
acquire an application list display interface;
transmit the application list display interface to the client;
receive a target application selected by the client in the application list display interface, and transmit a program interface corresponding to the target application to the client.

18. A computer-readable storage medium comprising a computer program stored thereon; wherein the computer program is executed by a processor to implement the application processing method according to claim 9.

19. The electronic device according to claim 17, wherein the processor is further configured to:
in a case that the identity information verification is unsuccessful, create a disk partition corresponding to the client;
after the disk partition is created, acquire a verification successful result corresponding to the client.

20. The electronic device according to claim 19, wherein the processor is further configured to: start a process corresponding to the disk partition, and acquire the application list display interface through the process.
